(19) United States
(12) Patent Application Publication
(10) Pub. No.: US 2014/0075213 A1
(43) Pub. Date: Mar. 13, 2014

(54) MANAGED CENTRALIZED POWER SUPPLY AND FIBER SPLITTER FOR FTTP DEPLOYMENT

(71) Applicant: TELLABS BEDFORD, Bedford, TX (US)

(72) Inventors: Maoping He, Shanghai (CN); Ning Ou-yang, Dallas, TX (US); Richard Schroder, Dallas, TX (US); Edward J. Szczebak, JR., Dallas, TX (US); Yangong Zhu, Shanghai (CN)

(73) Assignee: TELLABS BEDFORD, Bedford, TX (US)

(21) Appl. No.: 13/744,226

(22) Filed: Jan. 17, 2013

Related U.S. Application Data
(63) Continuation-in-part of application No. PCT/CN2012/081247, filed on Sep. 11, 2012.

(51) Int. Cl. G06F 1/26

(52) U.S. Cl. CPC G06F 1/26
USPC 713/300

(57) ABSTRACT

A network connection apparatus and system are described. The network connection apparatus includes a network interface for connection to a communication network, at least one power interface for connection to a powered network device, and at least one communication interface for connection to the powered network device. The communication interface is communicatively coupled to the network interface through a splitter. The network connection apparatus includes a bus connected to the at least one power interface, and a power supply electrically connected to the bus to supply power to the at least one power interface. The network connection apparatus may also include a communication terminal connected to the bus and to the splitter.

### BACKGROUND

1. Field

The exemplary embodiments described herein relate to a connection apparatus and system that facilitate connection of network components in a fiber-to-the-premises (FTTP) configuration.

2. Description of Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, equipment at a headend or central office couples the FTTx to external services such as a Public Switched Telephone Network (PSTN) or an external network. Signals received from these services are converted into optical signals and are transmitted using a single optical fiber at a plurality of wavelengths, with each wavelength defining a channel within the FTTx network.

In a FTTP network the optical signals are transmitted through the FTTP network to an optical splitter that splits the optical signals and transmits each individual optical signal over a single optical fiber to a subscriber's premises. At the subscriber's premises, the optical signal is converted into at least one electrical signal using an Optical Network Terminal (ONT). The ONT may split the resultant electrical signal into separate services required by the subscriber such as computer networking (data), telephony and video.

In FTTC and FTTN networks the optical signal is converted to at least one electrical signal by either an Optical Network Unit (ONU) (FTTC) or a Remote Terminal (RT) (FTTN), before being provided to a subscriber's premises.

A typical FTTx network, as shown in FIG. 1A, often includes one or more Optical Line Terminals (OLTs), which each include one or more Passive Optical Network (PON) cards. Each OLT typically is communicatively coupled to one or more ONTs (in the case of a FTTP network), or to one or more Optical Network Units (ONUs) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONUs are communicatively coupled to network terminals (NTs), and the NTs are communicatively coupled to CPE. NTs can be, for example, digital subscriber line (DSL) modems, asynchronous DSL (ADSL) modems, very high speed DSL (VDSL) modems, or the like.

In a FTTN network, such as that shown in FIG. 1A, each OLT typically can be communicatively coupled to one or more RTs. The RTs are communicatively coupled to NTs that are communicatively coupled to CPE.

OLTs communicate with ONTs (in the case of a FTTP network), or ONUs (in the case of a FTTC network) using the ONT Management and Control Interface (OMCI) control protocol as specified in ITU-T G.983.2 and ITU-T G.984.4. An OMCI Management Information Base (MIB), included in each device communicating using the OMCI protocol, defines the format of messages exchanged using the OMCI protocol.

An OLT can send an OMCI control message that controls an ONT or OLT to provide a service (e.g., a voice, data, and/or video service) by establishing a connection through which data is delivered from the OLT to CPE via the ONT or ONU. The ONT or ONU can send the OLT OMCI notification messages to notify the OLT of alarms.

Typically, the OMCI MIBs of OLTs and ONTs/ONUs are matched to define message formats in the same manner so that a message sent by one device can be properly processed by the receiving device. Otherwise, if the OMCI MIBs of OLTs and ONTs/ONUs define message formats differently, thus creating a MIB mismatch, a message sent by one device may not be supported by the receiving device. Typically, if an OLT, ONT, or ONU does not support a received message, the device may reject the entire message.

In a fiber-to-the-premises (FTTP) network configuration, such as that shown in FIG. 1B, a hybrid fiber 100 is used to connect a remote terminal or unit 104, such as an optical network terminal (ONT) (also referred to herein as ONT 104), with a centralized fiber splitter 106 and a centralized power supply 108. In the specific example embodiment shown in FIG. 1B, the hybrid fiber 100 includes a fiber optic cable 102 and a pair of copper wires 103 termed a “twisted pair”. One end of the fiber optic cable 102 is connected to the ONT while the other end is connected to a connector of the fiber splitter 106. One end of each of the copper wires is connected to the ONT 104, while the ends of the copper wires near the fiber splitter 106 are jumpered with jumper wires 105 to connectors on the centralized power supply 108. The wires 103 and 105 are used to route power from the centralized power supply 108 to the ONT 104, while the fiber 102 is used to route data between the centralized fiber splitter 106 and the ONT 104.

Typically, a plurality of ONTs 104 are connected to the fiber splitter 106 and the power supply 108. As shown in FIG. 1B, additional ONTs connected to the fiber splitter 106 and 108 utilize additional jumper wires 105 for connection to the centralized power supply 108.

The fiber splitter 106 is connected to an optical line terminal (OLT) 112 by a fiber optic connection 113, and the OLT 112 is in communication with an element management system (EMS) 114. EMS 114 can control and monitor various network elements, such as the ONTs 104. For example, the EMS 114 can monitor and configure communication services delivered to the ONTs 104. EMS 114 may be deployed for network applications, and can include hardware and software that enables an operator to monitor, control, and generally manage the network through a suitable user-interface, such as a Graphical User Interface (GUI). Although not shown in FIG. 1B for convenience, the EMS 114 is communicatively coupled to the OLT 112 and ONTs 104 for bidirectional communication.

The centralized power supply 108 is controlled by a power supply management system 110 that is separate from the EMS 114. Power supply management system 110 may be deployed for power supply applications, and can include hardware and software that enables an operator to monitor, control, and generally manage the power delivered to network elements, such as ONT 104, through a suitable user-interface, such as a Graphical User Interface (GUI). The power supply management system 110 manages the power supply arrangements between the power supply 108 and each ONT 104. The power transmission from the power supply 108 to each ONT 104 can be conventional direct current power transmission or power-over-ethernet (POE), in which case, the ONT's 104 can communicate over POE to the power supply 108.

The power supply 108 is typically connected to the power supply management system 110 by a craft interface (e.g., a local connection), or a networked interface (e.g., via an Ethernet interface). For example, a local connection can be made by connecting a personal computer (PC) to the power supply 108 using an RS232 cable and a serial communication protocol. The personal computer displays a graphical user interface to manage the configuration of the power supply 108. In the case of a networked interface, such personal computer can be connected remotely to a computer network that is connected to the power supply 108 so that the graphical user interface can be used to manage the configuration of the power supply 108.

In such a typical FTTP deployment described in FIG. 1B, network operators often deploy separate EMS 114 and power supply management 110 systems. The separate systems are considered undesirable because a separate network connection is extended to the location of the powers supply 108 and two separate systems must be managed.

Also, in a typical FTTP deployment, the centralized power supply 108 may be connected to hundreds of pairs of such jumper wires 105, which are not bundled together. Because of the large numbers of jumper wires terminating at the power supply 108, it can be difficult and time consuming to install and troubleshoot the jumper wiring due to a lack of wire management. The above and other limitations associated with the foregoing may be overcome by an apparatus and system in accordance with aspects described herein.

### SUMMARY

According to an example aspect of the invention a network connection apparatus and system are described. The network connection apparatus includes a network interface for connection to a communication network, at least one power interface for connection to a powered network device, and at least one communication interface for connection to the powered network device. The communication interface is communicatively coupled to the network interface through a splitter. The network connection apparatus includes a bus connected to the at least one power interface, and a power supply electrically connected to the bus to supply power to the at least one power interface. The network connection apparatus may also include a communication terminal connected to the bus and to the splitter.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, wherein:

FIG. 1A represents a conventional FTTx network.

FIG. 1B is schematic of a conventional FTTP configuration in a communication network.

FIG. 2 is a schematic of a connection apparatus in a communication network in accordance with an example aspect herein.

FIG. 3 is a wiring diagram of a multiconductor cable in accordance with an example aspect herein.

FIG. 4 is an architecture diagram of a data processing system in accordance with an example embodiment herein.

### DETAILED DESCRIPTION

Exemplary embodiments herein relate to an apparatus and system using a network connection apparatus. Those of ordinary skill in the art will realize in view of this description that the following detailed description of the exemplary embodiments is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference numbers will be used throughout the drawings and the following detailed description to refer to the same or like parts.

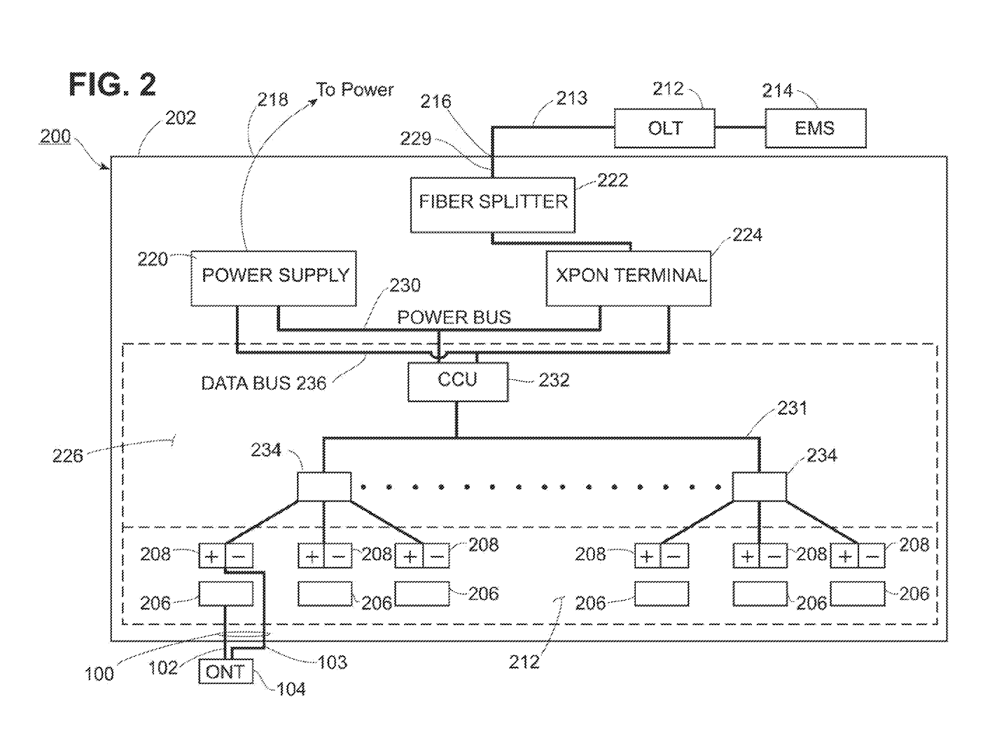

FIG. 2 shows a FTTP network arrangement 200 that includes an element management system (EMS) 214 that is communicatively coupled to optical line terminal (OLT) 112. Unlike EMS 114, EMS 214 also includes power management functionality, described further hereinbelow. OLT 112 is also communicatively coupled to a connection apparatus 202. The connection apparatus 202 is connected to the OLT 112 by a fiber connection 213. The connection apparatus 202 is also connected to ONTs 104 via hybrid fiber 100. The connection apparatus 202 routes bi-directional communication between the ONTs 104, the OLT 112, and the EMS 214, as well as routes power to each ONT 104, as described further hereinbelow.

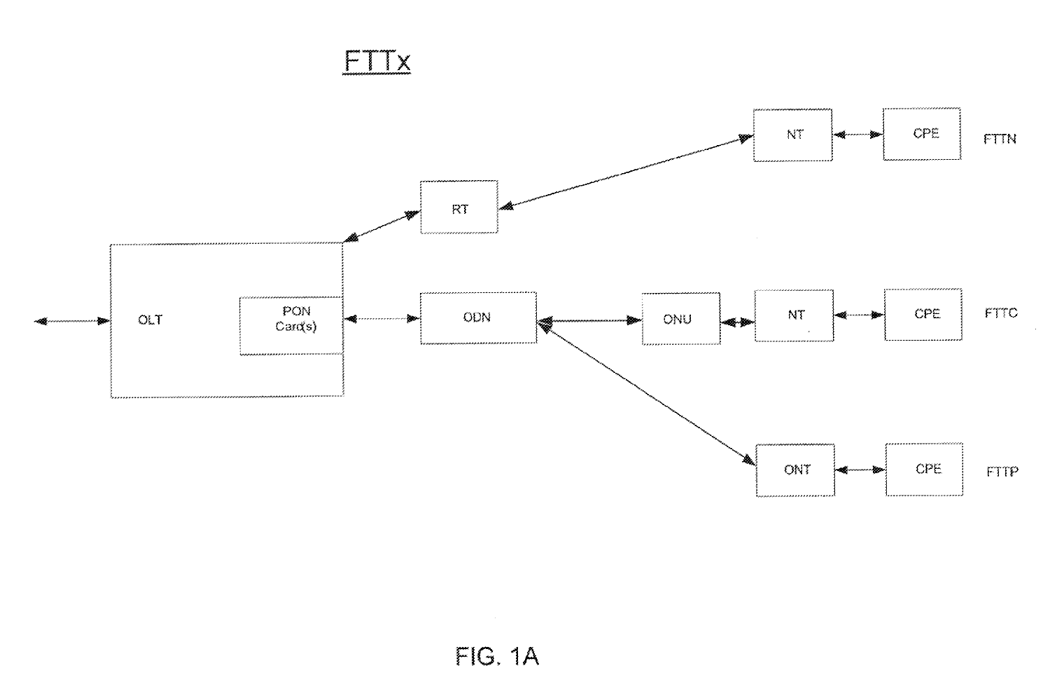

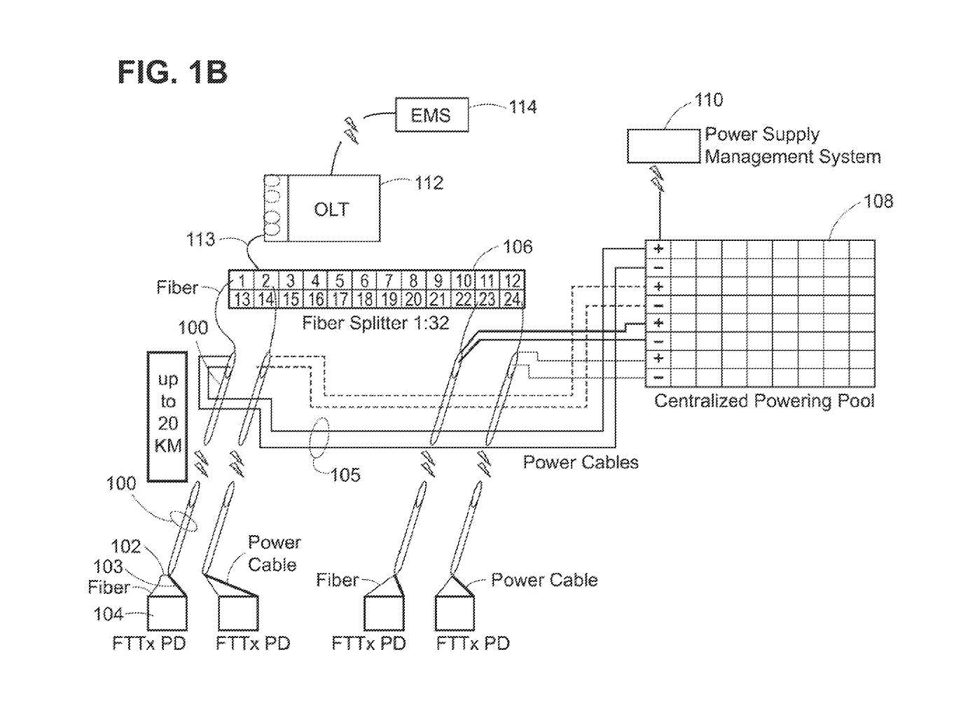

The connection apparatus 202 includes a plurality of pairs of connection interfaces 206/208 that can be connected to ONTs 104 via hybrid cable 100. For example, there can be 32 or 64 pairs of connection interfaces 206/208 on the connection apparatus 202 for connection to corresponding number of ONTs 104, though only one ONT 104 is shown connected in FIG. 2. In the example embodiment shown in FIG. 2, each connection interface 206 is constructed as a data interface and each connection interface 208 is constructed as a power interface. Of course, it should be appreciated that in the example embodiment of connection apparatus 202 shown in FIG. 2, each of the connection interfaces 206 and 208 can have multiple physical connectors for making the connections to fiber 102 and wires 103. In the example embodiment shown in FIG. 2, the connection interface 206 is a fiber connection interface having a single physical fiber connector for connection to a fiber optic connector of fiber 102 of hybrid fiber 100, which is connected to ONT 104. Also, the connection interface 208 is a power connection interface having a power connector for connection to a pair of copper wires 103 of hybrid fiber 100, which is connected to ONT 104. It should be noted that in other embodiments the hybrid fiber 100 is substituted with fiber 102 and wires 103 which are separated from each other (i.e., are not bundled together). Also, in one embodiment, the power connector may be a multiconductor connector, such as an RJ-45 or RJ-11 connector, and the wires 103 can be part of a multiconductor cable, such as a CAT-5 cable. In comparison with the power connections of FIG. 1, in the embodiment shown in FIG. 2, each power connection interface 208 is collocated with the fiber connection interface 206 instead of using a jumper wire 105 to connect to a power supply 108 that is separate from fiber splitter 106.

In the example embodiment shown in FIG. 2, the connection apparatus 202 is housed by housing 210. The housing 210 can be constructed to fit in a telecommunications equipment rack having an opening width that is, for example, nineteen inches. The housing 210 can also be constructed to have a height that is, for example, 1 or 2 rack units (RU). Housing 210 has a front panel 212 on which the connection interfaces 206/208 are disposed. Another connection interface 216 may be disposed on the housing 210 for connection to fiber 213 and another connection interface 218 may be disposed on the housing 210 for routing power to the connection apparatus 202.

Within housing 210, the connection apparatus 202 includes a power supply 220, a fiber splitter 222, a terminal management unit 224, and a circuit board 226. The fiber splitter 222 has a fiber connection 229 that communicatively couples fiber splitter 222 with connection interface 216. Fiber 213 connects between connection interface 216 and OLT 212. The fiber splitter 222 also is communicatively coupled to the terminal management unit 224, and at least some of the connection interfaces 206, which are coupled to some of the ONTs 104. The fiber splitter 222 is constructed to route data bi-directionally.

The terminal management unit 224, in one embodiment, is an x-Passive Optical Network (xPON) terminal, where x can be a G, E, or ATM. In such an embodiment, the terminal management unit 224 is treated like another of the ONTs 104 for purposes of communication with the EMS 214 and OLT 112, and is constructed to communicate with the EMS 214 through the fiber splitter 222 and the OLT 112. As a result of such communications with the EMS 214, the terminal management unit 224 is able to communicate information to the EMS 214 and OLT 112 related to the status of the power connection interfaces 208 and the data connection interfaces 206.

The circuit board 226 includes a bus 230 that is connected to the power supply 220, the terminal management unit 224, and to a central control unit 232. The circuit board 226 can be constructed, for example, as a printed circuit board. The power supply 220 is constructed to be electrically powered, such as by a power source capable of delivering 110/240 VAC or 48VDC. The central control unit 232 is connected through a power bus 231 to one or more power circuits 234, each of which is each connected to one or more connection interfaces 208 located at panel 212 of the connection apparatus 202.

The circuit board 226 also includes a data bus 236 that is connected to the power supply 220, the terminal management unit 224, and the central control unit 232. The central control unit 232 is constructed to receive, via the data bus 236, from the terminal management unit 224, commands generated by the EMS 214 or the OLT 112. In response to the commands it receives, the central control unit 232 can control the power supply 220 and power circuits 234 to regulate the distribution of power to each power connection interface 208 as described below.

Various protocols can be used for communication between the EMS 214, OLT 212, terminal management unit 224, and central control unit 232. Such protocols can include, for example, SNMP, Corba, XML, or any other suitable protocol. The communication between the terminal management unit 224 and the central control unit 232 can include chipset register operations. For example, the terminal management unit 224 can write a specific value to a register of the central control unit 224, and the central control unit 232 can use the written value to perform an operation, such as to send an output value to the power circuits 234.

The commands received by the central control unit 232 from the terminal management unit 224 can include a command to the power supply 220 to set the output voltage and/or current of one or more connection interfaces 208 and a command to shutdown/enable the power output to one or more connections 208. For example, the EMS 214 can be configured to store power output limits for each power connection interface 208. The EMS 214 can remotely manage the power distributed to each power connection interface 208 so that the power delivered is within the configured limits.

The central control unit 232 can monitor the status of each connection interface 208, such as by monitoring the load through each connection interface 208. The EMS 214 receives information from the central control unit 232 about the status of each power connection interface 208 and sends commands to the central control unit 232 in response to the received information. For example, the central control unit 232 can sense the output voltage and current in each power connection interface 208 and the sensed values can be sent and used by the EMS 214. In response to the sensed voltage and current values, for example, the EMS 214 can send a command to the central control unit 232 to set a power level for one or more power connection interfaces 208.

In at least one embodiment, the central control unit 232 can be constructed as a hardware processor having registers in which are stored values received from the terminal management unit 224 via the data bus 236. Such a processor can access the stored values and execute one or more processes based on those values. Also, in at least one other embodiment, the central control unit 232 can be constructed as a processor having registers where the processor can interpret commands received from the terminal management unit 232 and can write to the registers based on the result of the interpreted commands. In one example embodiment, the central control unit 232 can adjust the power level for each power connection interface 208 up to 30 Watts by regulating the output voltage up to 60 Volts.

Various methods of communicating between the central control unit 232 and the power circuits 234 can be employed. For example, the power circuits 234 can be constructed with a processor and registers which can be written to by the central control unit 232. The registers can be accessed by the processor of the power circuit 234 to control the power regulated to the connection interfaces 208.

In one embodiment, the central control unit 232 may also be constructed to monitor and control the power supply 220 independently of a command from the EMS 214. For example, if communication is interrupted between the connection apparatus 202 and the EMS 214, the central control unit 232 can detect the lost communication and take a predetermined action to preserve service to ONTs 104, such as to maintain all power levels just prior to the fault or to set a default power level to all of the connection interfaces 208. Also, if there is a fault in the wiring 103 between the connection apparatus 202 and one of the ONTs 104, the sensed voltage and current values may be used to trigger an alarm configured in the EMS 214.

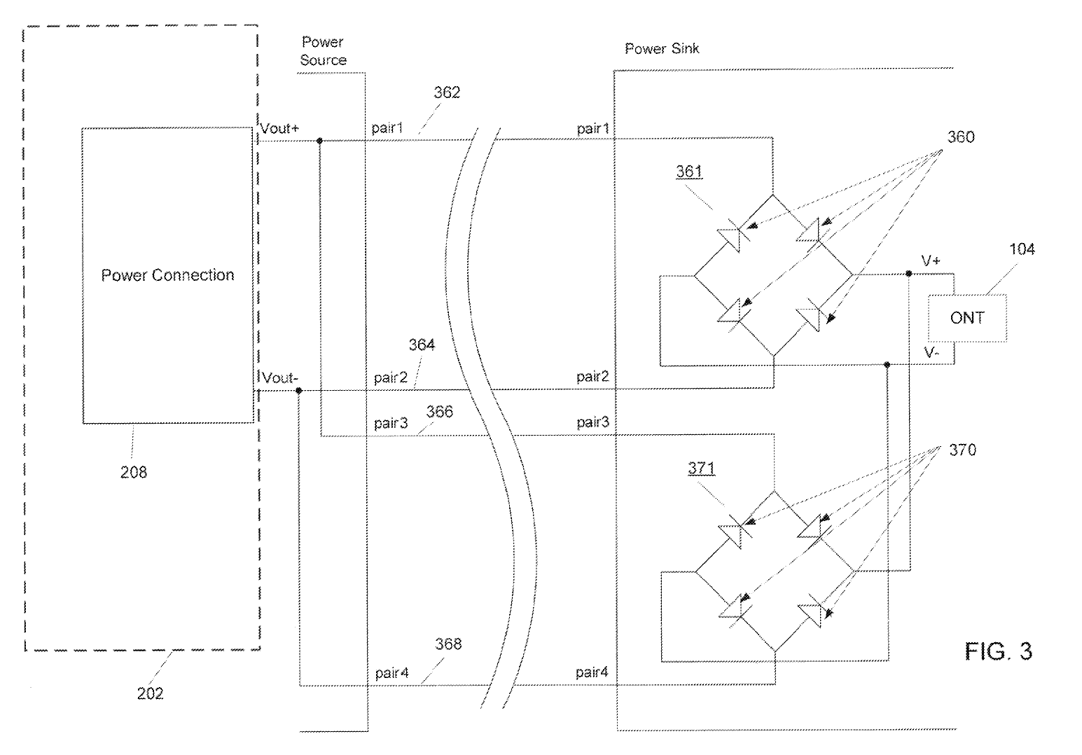

Another example aspect herein relates to the use of a plurality of pairs of wires in place of each twisted copper pair 103 shown in FIG. 2 between each connection interface 208 and ONT 104. As shown schematically in FIG. 3, a first pair of wires 362 is connected to a positive power connector (Vout+) of connection interface 208 on panel 212, while a second pair of wires 364 is connected to a negative power connector (Vout−) of connection interface 208 on panel 212. A third pair of wires 366 is connected in parallel with the first pair 362 of wires. A fourth pair of wires 368 is connected in parallel with the second pair of wires 364. Thus, in the embodiment shown in FIG. 3, a total of eight wires are used to electrically connect between connection interface 208 and power terminals (V+, V−) on ONT 104. The first and second pairs of wires 362 and 364 are connected at their power sink-ends to a first set of diodes 360 arranged as a diode bridge 361, which is connected to the power terminals (V+, V−) on ONT 104. Similarly, the third and fourth pairs of wires 366 and 368 are connected at their power sink-ends to a second set of diodes 370 arranged as a diode bridge 371, which is connected to the power terminals (V+, V−) on ONT 104. The diode bridges 361, 371 facilitate termination of the four pairs of wires 362, 364, 366, and 368, while arranging the proper polarity of the electrical connections at the ONT 104.

One advantage of using the plurality of pairs of wires (362, 364, 366, and 368) to distribute power to the ONT 104 is that the physical distance between the ONT 104 and the connection apparatus 202 can be larger, for example up to ten times than that of using a single twisted pair of wires.

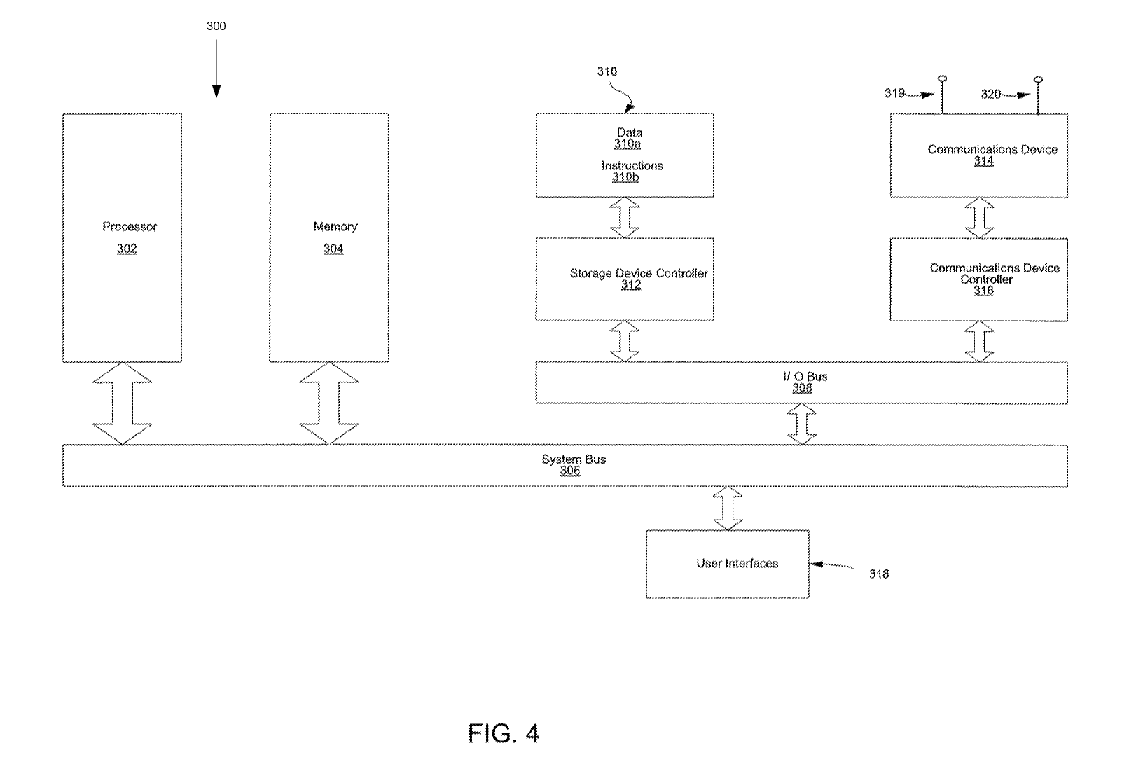

FIG. 4 is an architecture diagram of an example data processing system 300, which, according to an example embodiment, can represent the construction of one or more of the ONT 104, OLT 112, and connection apparatus 202 of FIG. 2, and components 104, 112, and 202 of FIG. 2, and/or any other type of a network device supporting a network control protocol, such as, for example, ONT Management and Control Interface (OMCI). Data processing system 300 includes a processor 302 coupled to a memory 304 via system bus 306. Processor 302 is also coupled to external Input/Output (I/O) devices (not shown) via the system bus 306 and an I/O bus 308, and at least one input/output user interface 318. Processor 302 may be further coupled to a communications interface 314 via a communications interface controller 316 coupled to the I/O bus 308. Processor 302 uses the communications interface 314 to communicate with a network, such as, for example, the network as shown in FIG. 2. In the case of at least the ONTs 104, interface 314 has data port 319 operably coupled to a network for sending and receiving data, and voice services data port 320 operably coupled to customer premises equipment (e.g., CPE) for sending and receiving voice data, but interface 314 may also have one or more additional input and output ports. A storage device 310 having a computer-readable medium is coupled to the processor 302 via a storage device controller 312 and the I/O bus 308 and the system bus 306. The storage device 310 is used by the processor 302 and controller 312 to store and read/write data 310a, and to store program instructions 310b used to implement the procedures described herein. The storage device 310 also stores various routines and operating programs (e.g., Microsoft Windows, UNIX/LINUX, or OS/2) that are used by the processor 302 for controlling the overall operation of the data processing system 300. In the case of a network device supporting a control protocol (e.g., OLT 112, ONTs 104 and connection apparatus 202 of FIG. 2), at least one of the programs stored in storage device 310 adheres to a control protocol (e.g., OMCI), for exchanging control messages and notification messages, and data 310a includes at least an OMCI Management Information Base (MIB) that defines the format of messages exchanged using the OMCI protocol. At least one of the programs (e.g., Microsoft Winsock) stored in storage device 310 can adhere to TCP/IP protocols (i.e., includes a TCP/IP stack), for implementing a known method for connecting to the Internet or another network.

In operation, processor 302 loads the program instructions 310b from the storage device 310 into the memory 304. Processor 302 then executes the loaded program instructions 310b to perform any of the example techniques described herein, for operating the data processing system 300 (which can represent the construction of one or more of ONTs 104, OLT 112, connection apparatus 202, and other devices supporting a control protocol).

In the foregoing description, specific example embodiments of the invention are described. Although described in the context of ONTs, ONUs, and OLTs, in other embodiments, the described methods can be performed by RTs, NTs, or any other types of network devices. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the example embodiments of the invention described herein.

Example software embodiments herein, if any, may be provided as a computer program product, or software, that may include an article of manufacture on a machine-accessible or machine-readable medium (memory) having instructions. The instructions on the machine-accessible or machine-readable medium may be used to program a computer system or other electronic device. The machine-readable medium may include, but is not limited to, floppy diskettes, optical disks, CD-ROMs, and magneto-optical disks or other types of media/machine-readable media suitable for storing or transmitting electronic instructions. The techniques described herein are not limited to any particular software configuration. They may find applicability in any computing or processing environment. The terms “machine-accessible medium” or “machine-readable medium” used herein, if at all, shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other example embodiments, functions performed by software can instead be performed by hardcoded modules, and thus example embodiments herein are not limited only for use with stored software programs.

In addition, it should be understood that the figures illustrated in the attached drawings, which highlight the functionality and advantages of the example embodiments described herein, are presented for example purposes only. The architecture of the example embodiments of the invention described herein is sufficiently flexible and configurable, such that it may be utilized (and navigated) in ways other than that shown in the accompanying figures.

Although example aspects have been described in certain specific example embodiments, many additional modifications and variations would be apparent to those skilled in the art. It is therefore to be understood that the example embodiments described herein may be practiced otherwise than as specifically described. Thus, these example embodiments of the invention should be considered in all respects as illustrative and not restrictive.

What is claimed is:

1. A network connection apparatus comprising:
a network interface for connection to a communication network;
at least one power interface for connection to a powered network device;
at least one communication interface for connection to the powered network device, the communication interface communicatively coupled to the network interface through a splitter;
a bus connected to the at least one power interface; and
a power supply electrically connected to the bus to distribute power to the at least one power interface.

2. The network connection apparatus according to claim 1, further comprising a communication terminal connected to the bus and to the splitter.

3. The network connection apparatus according to claim 2, wherein the communication terminal is constructed to communicate with the communication network to receive commands for setting the level of power output of the power supply distributed to the at least one power interface.

4. The network connection apparatus according to claim 1, wherein the bus comprises a printed circuit board.

5. The network connection apparatus according to claim 1, wherein the splitter is a fiber splitter having at least one connection to the communication network and at least one connection to the at least one communication interface.

6. A network connection apparatus comprising:
a power supply;
a splitter having a plurality of interfaces of a first type, the plurality of interfaces including at least one network interface for connection to a communication network;
a management unit connected to the splitter, the management unit arranged for communication with the communication network through the network interface;
a bus connected to the power supply and the management unit, the bus arranged to distribute power from the power supply to at least one of the splitter and the management unit; and
a plurality of couplers, including a first coupler of the first interface type connected to the splitter and at least a second coupler of a second interface type electrically connected to the power supply through the bus.

7. The apparatus according to claim 6, wherein the management unit is constructed to receive a command from the communication network for controlling the power distributed by the power supply to the second coupler.

8. The apparatus according to claim 6, wherein the second interface type is a power over Ethernet interface.

9. The apparatus according to claim 6, wherein one coupler of the first interface type and one coupler of the second interface type are constructed to be connected to an optical network terminal using a hybrid fiber.

10. The apparatus according to claim 6, wherein the bus is formed as a circuit board.

11. The apparatus according to claim 10, wherein the bus is formed as a power over Ethernet circuit board.

12. The apparatus according to claim 6, wherein the bus comprises a control unit constructed to control the power supply based on receiving a command from the communication network.

13. A connection system comprising:
a powered network device;
a hybrid fiber connected to the powered network device, wherein the hybrid fiber includes at least one optical fiber and at least one pair of wires;
a network interface for connection to a communication network;
at least one power interface connected to the at least one pair of wires;
at least one communication interface connected to the at least one optical fiber, the communication interface communicatively coupled to the network interface through a splitter;
a bus connected to the at least one power interface;
a power supply electrically connected to the bus to distributed power to the at least one power interface.

14. The system according to claim 13 further comprising a communication terminal connected to the bus and to the splitter.

15. The system according to claim 14, wherein the communication terminal is constructed to communicate with the communication network and to set a power level of power output of the power supply distributed to the at least one power interface.

16. The system according to claim 13, wherein the bus includes a printed circuit board.

17. The system according to claim 13, wherein the splitter is a fiber splitter having at least one connection to the communication network and at least one connection to the at least one communication interface.

18. The system according to claim 13, wherein the hybrid fiber includes a plurality of pairs of wires connected between the powered network device and the at least one power interface.

19. The system according to claim 18, wherein the pairs of wires are connected to a diode bridge at the powered network device.

20. The system according to claim 18, wherein the pairs of wires are constructed as one of CAT3, CAT4, CAT5, and CAT6 wires.
